(19) United States
(12) Patent Application Publication
(10) Pub. No.: US 2020/0159149 A1
(43) Pub. Date: May 21, 2020

(54) FIXING DEVICE AND IMAGE FORMING APPARATUS INCORPORATING SAME

(71) Applicants: Takumi WAIDA, Kanagawa (JP); Yoshio HATTORI, Kanagawa (JP); Yasunori ISHIGAYA, Kanagawa (JP); Yoshikuni SASAKI, Kanagawa (JP); Takahiro IMADA, Kanagawa (JP); Hironori YAMAOKA, Tochigi (JP); Hiromasa TAKAGI, Tokyo (JP); Keitaro SHOJI, Kanagawa (JP)

(72) Inventors: Takumi WAIDA, Kanagawa (JP); Yoshio HATTORI, Kanagawa (JP); Yasunori ISHIGAYA, Kanagawa (JP); Yoshikuni SASAKI, Kanagawa (JP); Takahiro IMADA, Kanagawa (JP); Hironori YAMAOKA, Tochigi (JP); Hiromasa TAKAGI, Tokyo (JP); Keitaro SHOJI, Kanagawa (JP)

(73) Assignee: Ricoh Company, Ltd., Tokyo (JP)

(21) Appl. No.: 16/676,673

(22) Filed: Nov. 7, 2019

(30) Foreign Application Priority Data
Nov. 15, 2018 (JP) 2018-214841
Apr. 16, 2019 (JP) 2019-077849

(51) Int. Cl. G03G 15/20; G03G 15/02

(52) U.S. Cl. CPC G03G 15/2025; G03G 15/2064; G03G 15/2039; G03G 15/0225; G03G 15/2035

(57) ABSTRACT

A fixing device includes a fixing rotator, a pressure rotator, a cleaner, a moving assembly, and a temperature detector. The fixing rotator heats and fixes a toner image onto a recording medium. The pressure rotator presses against the fixing rotator. The cleaner contacts and cleans a cleaning target, which includes one of the fixing rotator and the pressure rotator. The moving assembly moves the cleaner between a contact position where the cleaner contacts the cleaning target and a separate position where the cleaner is apart from the cleaning target. The temperature detector detects a temperature of one of the cleaner and the cleaning target. The moving assembly moves the cleaner from the contact position to the separate position or from the separate position to the contact position during rotation of the cleaning target, in a case in which the temperature detected is greater than a given value

### CROSS-REFERENCE TO RELATED APPLICATIONS

This patent application is based on and claims priority pursuant to 35 U.S.C. § 119(a) to Japanese Patent Application Nos. 2018-214841, filed on Nov. 15, 2018, and 2019-077849, filed on Apr. 16, 2019, in the Japan Patent Office, the entire disclosure of each of which is hereby incorporated by reference herein.

### BACKGROUND

### Technical Field

Embodiments of the present disclosure generally relate to a fixing device and an image forming apparatus incorporating the fixing device, and more particularly, to a fixing device for fixing a toner image onto a recording medium, and an image forming apparatus for forming an image on a recording medium with the fixing device.

### Related Art

Various types of electrophotographic image forming apparatuses are known, including copiers, printers, facsimile machines, and multifunction machines having two or more of copying, printing, scanning, facsimile, plotter, and other capabilities. Such image forming apparatuses usually form an image on a recording medium according to image data. Specifically, in such image forming apparatuses, for example, a charger uniformly charges a surface of a photoconductor as an image bearer. An optical writer irradiates the surface of the photoconductor thus charged with a light beam to form an electrostatic latent image on the surface of the photoconductor according to the image data. A developing device supplies toner to the electrostatic latent image thus formed to render the electrostatic latent image visible as a toner image. The toner image is then transferred onto a recording medium either directly, or indirectly via an intermediate transfer belt. Finally, a fixing device applies heat and pressure to the recording medium bearing the toner image to fix the toner image onto the recording medium. Thus, an image is formed on the recording medium.

Such a fixing device typically includes a fixing rotator, such as a roller, a belt, and a film, and a pressure rotator, such as a roller and a belt, pressed against the fixing rotator. The fixing rotator and the pressure rotator apply heat and pressure to the recording medium, melting and fixing the toner image onto the recording medium while the recording medium is conveyed between the fixing rotator and the pressure rotator. The fixing device may also include a cleaner that contacts and cleans a surface of the fixing rotator or the pressure rotator.

### SUMMARY

In one embodiment of the present disclosure, a novel fixing device includes a fixing rotator, a pressure rotator, a cleaner, a moving assembly, and a temperature detector. The fixing rotator is configured to heat a toner image and fix the toner image onto a surface of a recording medium. The pressure rotator is configured to press against the fixing rotator to form a fixing nip through which the recording medium is conveyed between the fixing rotator and the pressure rotator. The cleaner is configured to contact and clean a surface of a cleaning target. The cleaning target includes one of the fixing rotator and the pressure rotator. The moving assembly is configured to move the cleaner between a contact position at which the cleaner contacts the surface of the cleaning target and a separate position at which the cleaner is apart from the surface of the cleaning target. The temperature detector is configured to detect a temperature of one of the cleaner and the cleaning target. The moving assembly is configured to move the cleaner from the contact position to the separate position or from the separate position to the contact position during rotation of the cleaning target, in a case in which the temperature detected by the temperature detector is greater than a given value.

Also described is a novel image forming apparatus incorporating the fixing device.

### BRIEF DESCRIPTION OF THE DRAWINGS

A more complete appreciation of the embodiments and many of the attendant advantages and features thereof can be readily obtained and understood from the following detailed description with reference to the accompanying drawings, wherein:

FIG. 1 is a schematic view of an image forming apparatus according to an embodiment of the present disclosure;

FIG. 2 is a diagram illustrating a configuration of a fixing device incorporated in the image forming apparatus of FIG. 1;

FIG. 3 is a cross-sectional view of the fixing device, illustrating a cleaning roller apart from a pressure roller;

FIG. 4A is a diagram illustrating rotary motions of the pressure roller in association with separation of the cleaning roller from the pressure roller when a detected temperature is equal to or smaller than a given value;

FIG. 4B is a diagram illustrating rotary motions of the pressure roller in association with separation of the cleaning roller from the pressure roller when the detected temperature is greater than the given value;

FIG. 5A is a diagram illustrating rotary motions of the pressure roller in association with the cleaning roller coming into contact with the pressure roller when the detected temperature is equal to or smaller than the given value;

FIG. 5B is a diagram illustrating rotary motions of the pressure roller in association with the cleaning roller coming into contact with the pressure roller when the detected temperature is greater than the given value;

FIG. 6A is a timing chart illustrating a rotation control of the pressure roller and a contact/separation control of the cleaning roller when the detected temperature is equal to or smaller than the given value;

FIG. 6B is a timing chart illustrating the rotation control of the pressure roller and the contact/separation control of the cleaning roller when the detected temperature is greater than the given value;

FIG. 7 is a flowchart illustrating the contact/separation control of the cleaning roller and a driving control of the fixing device;

FIG. 8A is a diagram illustrating rotary motions of the pressure roller in association with separation of the cleaning roller from the pressure roller in a comparative fixing device;

FIG. 8B is a diagram illustrating rotary motions of the pressure roller in association with the cleaning roller coming into contact with the pressure roller in the comparative fixing device;

FIG. 9 is a timing chart illustrating a first variation of the rotation control of the pressure roller and the contact/separation control of the cleaning roller, together with a graph of changes in the detected temperature;

FIG. 10 is a timing chart illustrating a second variation of the rotation control of the pressure roller and the contact/separation control of the cleaning roller;

FIG. 11 is a timing chart illustrating a third variation of the contact/separation control of the cleaning roller;

FIG. 12A is a timing chart illustrating a fourth variation of the contact/separation control of the cleaning roller when the pressure roller rotates;

FIG. 12B is a timing chart illustrating the fourth variation of the contact/separation control of the cleaning roller when the pressure roller stops rotation;

FIG. 13 is a cross-sectional view of a first variation of the fixing device;

FIG. 14A is a cross-sectional view of a first example of a second variation of the fixing device; and

FIG. 14B is a cross-sectional view of a second example of the second variation of the fixing device.

The accompanying drawings are intended to depict embodiments of the present disclosure and should not be interpreted to limit the scope thereof. Also, identical or similar reference numerals designate identical or similar components throughout the several views.

### DETAILED DESCRIPTION

In describing embodiments illustrated in the drawings, specific terminology is employed for the sake of clarity. However, the disclosure of the present specification is not intended to be limited to the specific terminology so selected and it is to be understood that each specific element includes all technical equivalents that have a similar function, operate in a similar manner, and achieve a similar result.

Although the embodiments are described with technical limitations with reference to the attached drawings, such description is not intended to limit the scope of the disclosure and not all of the components or elements described in the embodiments of the present disclosure are indispensable to the present disclosure.

In a later-described comparative example, embodiment, and exemplary variation, for the sake of simplicity like reference numerals are given to identical or corresponding constituent elements such as parts and materials having the same functions, and redundant descriptions thereof are omitted unless otherwise required.

As used herein, the singular forms “a”, “an”, and “the” are intended to include the plural forms as well, unless the context clearly indicates otherwise.

It is to be noted that, in the following description, suffixes Y, M, C, and BK denote colors of yellow, magenta, cyan, and black, respectively. To simplify the description, these suffixes are omitted unless necessary.

Referring to the drawings, wherein like reference numerals designate identical or corresponding parts throughout the several views, embodiments of the present disclosure are described below.

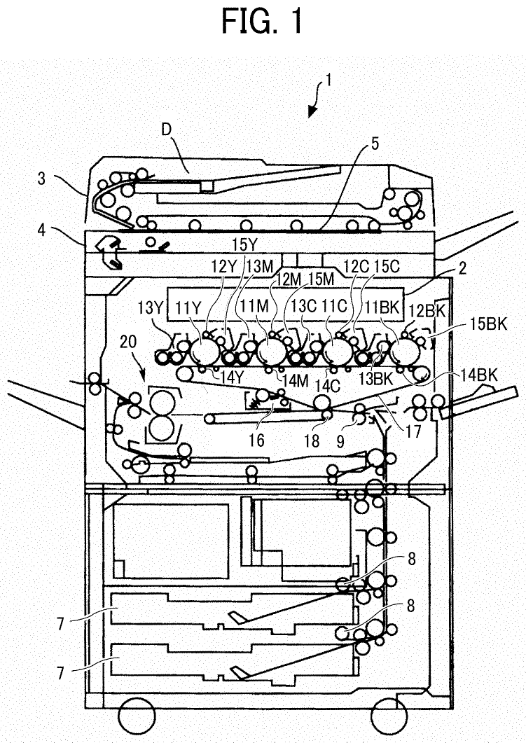

Initially with reference to FIG. 1, a description is given of overall configuration and operation of an image forming apparatus 1 according to an embodiment of the present disclosure.

FIG. 1 is a schematic view of the image forming apparatus 1.

The image forming apparatus 1 may be, e.g., a copier, a facsimile machine, a printer, or a multifunction peripheral (MFP) having at least two of copying, printing, scanning, facsimile, and plotter functions.

FIG. 1 illustrates the image forming apparatus 1 as a color copier that employs a tandem structure and forms color and monochrome images on recording media by electrophotography. The image forming apparatus includes, e.g., a writer 2, a document feeder 3, and a scanner 4. The writer 2 emits laser light according to input image data. The document feeder 3 feeds or conveys a document D to the scanner 4. The scanner 4 reads image data of the document D.

The image forming apparatus 1 further includes a sheet feeder 7 (in this case, a plurality of sheet feeders 7), a registration roller pair 9 (also referred to as a timing roller pair), and four drum-shaped photoconductors 11Y, 11M, 11C, and 11BK. The sheet feeder 7 accommodates one or more sheets P such as paper sheets. The registration roller pair 9 adjusts a conveyance timing of the sheet P. The photoconductors 11Y, 11M, 11C, and 11BK bear toner images of yellow, magenta, cyan, and black, respectively.

Each of the photoconductors 11Y, 11M, 11C, and 11BK is surrounded by various pieces of equipment. For example, the photoconductor 11Y is surrounded by a charger 12Y, a developing device 13Y, a primary-transfer bias roller 14Y, and a cleaner 15Y. Like the photoconductor 11Y, the photoconductors 11M, 11C, and 11BK are surrounded by chargers 12M, 12C, and 12BK, developing devices 13M, 13C, and 13BK, primary-transfer bias rollers 14M, 14C, and 14BK, and cleaners 15M, 15C, and 15BK, respectively. The chargers 12Y, 12M, 12C, and 12BK charge the surface of the photoconductors 11Y, 11M, 11C, and 11BK, respectively. The developing devices 13Y, 13M, 13C, and 13BK develop, as visible toner images, electrostatic latent images formed on the surface of the photoconductors 11Y, 11M, 11C, and 11BK, respectively. The primary-transfer bias rollers 14Y, 14M, 14C, and 14BK transfer the toner images from the surface of the photoconductors 11Y, 11M, 11C, and 11BK, respectively, onto an outer circumferential surface of an intermediate transfer belt 17 such that the toner images are superimposed one atop another on the intermediate transfer belt 17. The cleaners 15Y, 15M, 15C, and 15BK remove and collect residual toner from the surface of the photoconductors 11Y, 11M, 11C, and 11BK, respectively. The residual toner refers to toner that has failed to be transferred onto the intermediate transfer belt 17 and therefore remains on the surface of the respective photoconductors 11Y, 11M, 11C, and 11BK.

The image forming apparatus 1 further includes an intermediate transfer belt cleaner 16, the intermediate transfer belt 17, a secondary-transfer bias roller 18, and a fixing device 20. The intermediate transfer belt cleaner 16 cleans the intermediate transfer belt 17. The intermediate transfer belt 17 bears different colors of toner images superimposed one atop another. The secondary-transfer bias roller 18 transfers the toner images from the intermediate transfer belt 17 onto the sheet P as a composite color toner image. The fixing device 20 fixes the unfixed color toner image onto the sheet P.

To provide a fuller understanding of the embodiments of the present disclosure, a description is now given of a general image forming operation of the image forming apparatus 1 to form or print a color image, with continued reference to FIG. 1.

The document feeder 3 conveys, with conveyance rollers, the document D from a document tray onto an exposure glass 5 (also referred to as a platen) of the scanner 4. Thus, the document D is loaded on the exposure glass 5. The scanner 4 optically reads the image data of the document D loaded on the exposure glass 5.

Specifically, the scanner 4 irradiates an image of the document D on the exposure glass 5 with light emitted from a light source (e.g., a lamp), thereby scanning the image of the document D. The light reflected by the document D is reflected by a plurality of mirrors, travels through a lens, and enters a color sensor that forms an image. The color sensor reads the image data (or color image data) of the document D into color separation light in red (R), green (G), and blue (B) and converts the light into electric signals. An image processor of the scanner 4 performs a plurality of processes, such as color conversion, color correction, and spatial frequency correction, based on the electric signals (specifically, RGB color separation image signals). As a consequence, the scanner 4 obtains color image data of yellow, magenta, cyan, and black.

The image data of yellow, magenta, cyan, and black is sent to the writer 2. The writer 2 emits laser light or beams (e.g., exposure light) onto the surface of the photoconductors 11Y, 11M, 11C, and 11BK according to the image data of yellow, magenta, cyan, and black, respectively.

Each of the four photoconductors 11Y, 11M, 11C, and 11BK rotates counterclockwise in FIG. 1. The chargers 12Y, 12M, 12C, and 12BK disposed opposite the photoconductors 11Y, 11M, 11C, and 11BK uniformly charge the surface of the photoconductors 11Y, 11M, 11C, and 11BK, respectively, in a charging process. Thus, a charging potential is produced on the surface of each of the photoconductors 11Y, 11M, 11C, and 11BK.

Thereafter, the charged surface of the respective photoconductors 11Y, 11M, 11C, and 11BK reaches an irradiation position to be irradiated with a laser beam from the writer 2. Specifically, four light sources of the writer 2 emit laser beams corresponding to the image data of yellow, magenta, cyan, and black onto the photoconductors 11Y, 11M, 11C, and 11BK through separate optical paths, respectively, in an exposure process.

For example, the surface of the leftmost photoconductor 11Y in FIG. 1 is irradiated with a laser beam corresponding to the image data of yellow. A polygon mirror rotated at high speed directs the laser beam corresponding to the image data of yellow in an axial direction of the photoconductor 11Y, that is, a main scanning direction. The axial direction of the photoconductors 11Y, 11M, 11C, and 11BK may be hereinafter referred to as a width direction. Thus, an electrostatic latent image corresponding to the image data of yellow is formed on the photoconductor 11Y charged by the charger 12Y.

Similarly, the surface of the second photoconductor 11M from left in FIG. 1 is irradiated with a laser beam corresponding to the image data of magenta. Thus, an electrostatic latent image corresponding to the image data of magenta is formed on the photoconductor 11M. The surface of the third photoconductor 11C from left in FIG. 1 is irradiated with a laser beam corresponding to the image data of cyan. Thus, an electrostatic latent image corresponding to the image data of cyan is formed on the photoconductor 11C. The surface of the fourth photoconductor 11BK from left in FIG. 1 is irradiated with a laser beam corresponding to the image data of black. Thus, an electrostatic latent image corresponding to the image data of black is formed on the photoconductor 11BK.

Thereafter, the surface of the respective photoconductors 11Y, 11M, 11C, and 11BK bearing the electrostatic latent image reaches a developing position opposite the respective developing devices 13Y, 13M, 13C, and 13BK. The developing devices 13Y, 13M, 13C, and 13BK supply toner of yellow, magenta, cyan, and black to the photoconductors 11Y, 11M, 11C, and 11BK, developing the electrostatic latent images formed on the photoconductors 11Y, 11M, 11C, and 11BK into toner images of yellow, magenta, cyan, and black, respectively, in a developing process.

The toner images thus formed on the photoconductors 11Y, 11M, 11C, and 11BK, respectively, reach primary transfer positions opposite the intermediate transfer belt 17. The primary-transfer bias rollers 14Y, 14M, 14C, and 14BK are disposed opposite the photoconductors 11Y, 11M, 11C, and 11BK via the intermediate transfer belt 17 at the primary transfer positions. Specifically, the primary-transfer bias rollers 14Y, 14M, 14C, and 14BK contact an inner circumferential surface of the intermediate transfer belt 17 to form four areas of contact, herein called primary transfer nips, between the intermediate transfer belt 17 and the photoconductors 11Y, 11M, 11C, and 11BK, respectively. At the primary transfer nips, the toner images of yellow, magenta, cyan, and black formed on the respective photoconductors 11Y, 11M, 11C, and 11BK are transferred onto the intermediate transfer belt 17 successively such that the toner images of yellow, magenta, cyan, and black are superimposed one atop another on the intermediate transfer belt 17 in a primary transfer process.

After the primary transfer process, the surface of the respective photoconductors 11Y, 11M, 11C, and 11BK reaches a cleaning position opposite the respective cleaners 15Y, 15M, 15C, and 15BK. The cleaners 15Y, 15M, 15C, and 15BK remove and collect the residual toner from the surface of the photoconductors 11Y, 11M, 11C, and 11BK, respectively, in a cleaning process. As described above, the residual toner is toner that has failed to be transferred onto the intermediate transfer belt 17 and therefore remains on the surface of the respective photoconductors 11Y, 11M, 11C, and 11BK.

Thereafter, a discharger discharges the surface of the respective photoconductors 11Y, 11M, 11C, and 11BK, thus completing a series of image forming processes performed on the photoconductors 11Y, 11M, 11C, and 11BK.

On the other hand, as the intermediate transfer belt 17 rotates clockwise in FIG. 1, the toner images of yellow, magenta, cyan, and black superimposed one atop another on the intermediate transfer belt 17 reach a secondary transfer position at which the intermediate transfer belt 17 faces the secondary-transfer bias roller 18 and forms an area of contact, herein called a secondary transfer nip, between the intermediate transfer belt 17 and the secondary-transfer bias roller 18. At the secondary transfer nip, the secondary-transfer bias roller 18 transfers the toner images of yellow, magenta, cyan, and black from the intermediate transfer belt 17 onto a sheet P as a composite color toner image in a secondary transfer process.

Thereafter, the outer circumferential surface of the intermediate transfer belt 17 reaches a cleaning position opposite the intermediate transfer belt cleaner 16. The intermediate transfer belt cleaner 16 removes and collects residual toner from the intermediate transfer belt 17, thus completing a series of transfer processes performed on the intermediate transfer belt 17. Note that the residual toner is herein toner that has failed to be transferred onto the sheet P and therefore remains on the intermediate transfer belt 17.

The sheet P is conveyed from the sheet feeder 7 via, e.g., the registration roller pair 9 to the secondary transfer nip between the intermediate transfer belt 17 and the secondary-transfer bias roller 18. At the secondary transfer nip, the color toner image is formed on the sheet P thus conveyed.

Specifically, one of a plurality of sheet feeding rollers 8 picks up and feeds the sheet P from the corresponding sheet feeder 7 that accommodates a plurality of sheets P. The sheet P is conveyed along a conveyance passage, defined by internal components of the image forming apparatus 1, toward the registration roller pair 9. After the sheet P reaches the registration roller pair 9, activation of the registration roller pair 9 is timed to send out the sheet P toward the secondary transfer nip such that the sheet P meets the toner images of yellow, magenta, cyan, and black on the intermediate transfer belt 17 at the secondary transfer nip.

A conveyance belt conveys the sheet P bearing the color toner image toward the fixing device 20. The fixing device 20 fixes the color toner image onto a surface of the sheet P at an area of contact, herein called a fixing nip, between a fixing roller and a pressure roller in a fixing process.

After the fixing process, a sheet ejection roller pair ejects the sheet P bearing the fixed color toner image as an output image toward an outside of the image forming apparatus 1, thus completing a series of image forming processes as a print operation.

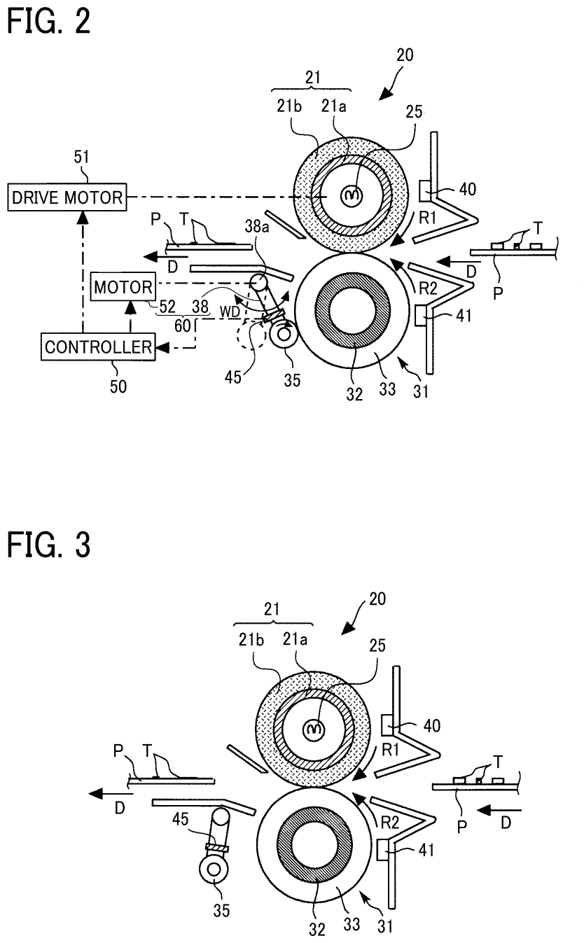

Referring now to FIGS. 2 to 7, a description is given of a configuration and operation of the fixing device 20 incorporated in the image forming apparatus 1 described above.

Initially with reference to FIG. 2, a description is given of a configuration of the fixing device 20.

FIG. 2 is a diagram illustrating the configuration of the fixing device 20.

As illustrated in FIG. 2, the fixing device 20 includes a fixing roller 21 serving as a fixing rotator, a heater 25, a pressure roller 31 serving as a pressure rotator, a cleaning roller serving as a cleaner, temperature sensors 40, 41, and 45 serving as temperature detectors, and a moving assembly 60. The moving assembly 60 is constructed of an arm 38 and a motor 52.

The fixing roller 21 (i.e., fixing rotator) is a multi-layer roller constructed of a core 21a, an elastic layer 21b resting on the core 21a, and a release layer resting on the elastic layer 21b as a surface layer. The core 21a is a hollow core made of a metal material such as stainless steel. The fixing roller 21 presses against the pressure roller 31 (i.e., pressure rotator) thereby forming a fixing nip between the fixing roller 21 and the pressure roller 31.

The elastic layer 21b of the fixing roller 21 is made of an elastic material such as fluoro rubber, silicon rubber, or silicon rubber foam. The release layer of the fixing roller 21 is made of tetrafluoroethylene-perfluoroalkylvinylether copolymer (PFA) or the like. The release layer, serving as a surface layer of the fixing roller 21, facilitates separation or peeling-off of toner T contained in a toner image from the fixing roller 21. A drive motor 51 drives and rotates the fixing roller 21 in a clockwise direction of rotation R1 in FIG. 2.

The heater 25 is a heat source secured inside the hollow core 21a of the fixing roller 21 to heat the fixing roller 21.

The heater 25 is herein a halogen heater. Opposed longitudinal ends of the heater are secured to side plates of the fixing device 20, respectively. When the image forming apparatus 1 is powered on, a power supply supplies power to the heater 25. A controller 50 causes the heater 25 to output radiation heat to heat the fixing roller 21. The heat is conducted from an outer circumferential surface of the fixing roller 21, which is heated by the heater 25, to the toner image containing the toner T on the sheet P.

The controller 50 controls the output of the heater 25 based on a surface temperature of the fixing roller 21 (specifically, a temperature of the outer circumferential surface of the fixing roller 21) detected by the temperature sensor 40. The temperature sensor 40 is disposed opposite the outer circumferential surface of the fixing roller 21 without contacting the outer circumferential surface of the fixing roller 21. Specifically, an alternating current (AC) voltage is applied to the heater 25 for an energization time determined based on the temperature detected by the temperature sensor 40 (e.g., thermopile). With such output control of the heater 25, the temperature of the fixing roller 21 (or fixing temperature) is adjusted to a desired temperature (or a target control temperature).

The pressure roller 31 (i.e., pressure rotator) is mainly constructed of a core 32 and an elastic layer 33 resting an outer circumferential surface of the core 32 via an adhesion layer. The elastic layer 33 of the pressure roller 31 is made of a material such as silicon rubber foam, fluoro rubber, or silicon rubber. Optionally, a thin release layer made of PFA or the like may rest on an outer circumferential surface of the elastic layer 33.

A pressure device presses the pressure roller 31 against the fixing roller 21, thus forming a desired fixing nip between the pressure roller 31 and the fixing roller 21.

The pressure roller 31 is rotated in a counterclockwise direction of rotation R2 in FIG. 2 by the fixing roller 21 that rotates in the clockwise direction of rotation R1 in FIG. 2. As described above, the fixing device 20 of the present embodiment includes the cleaning roller 35, the moving assembly 60, and the temperature sensor 45. The cleaning roller 35 (i.e., cleaner) removes extraneous matter such as toner and paper dust adhering to a surface of the pressure roller 31, thus cleaning the surface of the pressure roller 31. That is, the pressure roller 31 is herein a cleaning target for the cleaning roller 35. The moving assembly 60, constructed of the arm 38 and the motor 52, causes the cleaning roller 35 to contact the pressure roller 31 and separates the cleaning roller 35 from the pressure roller 31. The temperature sensor 45 (i.e., temperature detector) detects a temperature of the cleaning roller 35. A detailed description of the cleaning roller 35, the moving assembly 60, and the temperature sensor 45 is deferred.

With continued reference to FIG. 2, a description is now given of operation of the fixing device 20 configured as described above.

When the image forming apparatus 1 is powered on, the heater 25 is supplied with power. In other words, the AC voltage is applied to the heater 25.

In response to a print command or print request, the drive motor 51, serving as a driving device, starts rotating the fixing roller 21 clockwise in FIG. 2. Meanwhile, the pressure roller 31 starts rotating counterclockwise in FIG. 2 in accordance with the clockwise rotation of the fixing roller 21. Then, at the secondary transfer nip between the intermediate transfer belt 17 and the secondary-transfer bias roller 18, a toner image is transferred from the intermediate transfer belt 17 onto a sheet P fed from the sheet feeder 7. Thus, the sheet P bears the toner image as an unfixed toner image. As illustrated in FIG. 2, the sheet P bearing the unfixed toner image (i.e., toner image containing the toner T) is conveyed in a direction D (hereinafter referred to as a sheet conveyance direction D) and enters the fixing nip between the fixing roller 21 and the pressure roller 31 pressed against the fixing roller 21. At the fixing nip, the toner image containing the toner T is fixed onto a surface of the sheet P under heat from the fixing roller 21 and pressure exerted from the fixing roller 21 and the pressure roller 31. Thus, the sheet P bears the toner image as a fixed toner image. Then, the sheet P bearing the fixed toner image is sent out of the fixing nip in the sheet conveyance direction D by the fixing roller 21 and the pressure roller 31 as the fixing roller 21 and the pressure roller 31 rotate.

With reference to FIGS. 2 and 3, a detailed description is now given of the configuration and operation of the fixing device 20 in the image forming apparatus 1.

FIG. 3 is a cross-sectional view of the fixing device 20, illustrating the cleaning roller apart from the pressure roller 31.

As described above with reference to FIG. 2, the fixing device 20 includes the fixing roller 21 (i.e., fixing rotator) and the pressure roller 31 (i.e., pressure rotator). The fixing roller 21 heats the toner image to fix the toner image onto the surface of the sheet P. The pressure roller 31 presses against the fixing roller 21 to form the fixing nip through which the sheet P is conveyed between the fixing roller 21 and the pressure roller 31.

In addition, the fixing device 20 of the present embodiment includes the cleaning roller 35 (i.e., cleaner) and the temperature sensor 45 (i.e., temperature detector).

Referring to FIGS. 2 and 3, as the moving assembly 60 constructed of the arm 38 and the motor 52 operates, the cleaning roller 35 (i.e., cleaner) is movable between a contact position (indicated by a solid line in FIG. 2) and a separate position (indicated by a broken line in FIG. 2 and illustrated in FIG. 3). In other words, the moving assembly 60 moves the cleaning roller 35 between the contact position and the separate position. At the contact position, the cleaning roller 35 contacts the surface of the pressure roller 31 (i.e., pressure rotator) serving as a cleaning target. At the separate position, the cleaning roller 35 is apart from the surface of the pressure roller 31.

Specifically, in the present embodiment, the cleaning roller 35 is a metal roller rotatably held by the arm 38. In other words, the arm 38 rotatably holds the cleaning roller 35. The cleaning roller 35 contacts the surface of the pressure roller 31 and removes extraneous matter such as toner and paper dust from the surface of the pressure roller 31. Thus, the cleaning roller 35 cleans the surface of the pressure roller 31. As the surface of the pressure roller 31 is directly cleaned by the cleaning roller 35, the surface of the fixing roller 21 is indirectly cleaned. As a consequence, unfavorable situations are prevented. For example, the sheet P is prevented from being soiled by toner or paper dust while passing through the fixing nip. In addition, a partial loss of an image is prevented.

Particularly in the present embodiment, the cleaning roller 35 rotates together with the pressure roller 31 (i.e., cleaning target) when the cleaning roller 35 is in contact with the pressure roller 31 rotating in a given direction. As the cleaning roller 35 rotates, different portions of the surface of the cleaning roller 35 contact the surface of the pressure roller 31. Accordingly, the cleaning roller 35 efficiently cleans the surface of the pressure roller 31.

The arm 38 is held by a housing of the fixing device 20 such that the arm 38 is swingable about a pivot 38a in a double-headed arrow direction (hereinafter simply referred to as a direction WD) in FIG. 2. The motor 52, as a forward/reverse bidirectional rotary motor, is connected to the pivot 38a of the arm 38 via a gear train.

When the motor 52 is driven in a forward direction under the control of the controller 50, the arm 38 rotates about the pivot 38a counterclockwise in FIG. 2. In other words, the motor 52 rotates the arm 38c counterclockwise in FIG. 2. Accordingly, the cleaning roller comes into contact with the pressure roller 31 as illustrated in FIG. 2. In short, the cleaning roller 35 moves to the contact position as illustrated in FIG. 2. On the other hand, when the motor 52 is driven in a reverse direction under the control of the controller 50, the arm 38 rotates about the pivot 38a clockwise in FIG. 2. In other words, the motor 52 rotates the arm 38c clockwise in FIG. 2. Accordingly, the cleaning roller 35 is separated from the pressure roller 31 as illustrated in FIG. 3. In short, the cleaning roller 35 moves to the separate position as illustrated in FIG. 3.

That is, the motor 52 and the arm 38 construct the moving assembly 60 to move the cleaning roller 35.

As described above, the moving assembly 60 constructed of the arm 38 and the motor 52 allows the cleaning roller 35 to come apart from the cleaning roller 35. Compared to a comparative configuration in which a cleaning roller keeps in contact with a pressure roller, the configuration of the present embodiment prevents unfavorable situations such as deformation of the cleaning roller 35 and solidification of toner at the contact position or pressure contact position at which the cleaning roller 35 is pressed against the pressure roller 31.

In the comparative configuration, the cleaning roller keeps in pressure contact with the pressure roller for a relatively long period of time after a fixing device stops driving. As a consequence, the toner positioned at the pressure contact portion may be solidified. The cleaning roller and the pressure roller may be deformed at the pressure contact position. By contrast, in the present embodiment, the cleaning roller 35 is separable from the pressure roller 31 so that the cleaning roller 35 does not keep in contact with the pressure roller 31 for a relatively long period of time when the fixing device 20 stops driving. Thus, the configuration of the present embodiment prevents the unfavorable situations as described above.

With continued reference to FIGS. 2 and 3, the temperature sensor 45 (i.e., temperature detector) detects the temperature of the cleaning roller 35 (i.e., cleaner).

Specifically, as illustrated in FIGS. 2 and 3, the temperature sensor 45 is a non-contact temperature sensor such as a thermopile or a non-contact thermistor. The temperature sensor 45 is held by the arm 38 such that a detection surface of the temperature sensor 45 faces the cleaning roller 35. That is, the temperature sensor 45 is disposed opposite the cleaning roller 35 to detect the temperature of the cleaning roller 35 at any time, regardless of whether the cleaning roller 35 is in contact with the pressure roller 31 or apart from the pressure roller 31.

In the fixing device 20 according to the present embodiment, in a case in which the temperature detected by the temperature sensor 45 (i.e., temperature detector) is greater than a given value A, the moving assembly 60, constructed of the arm 38 and the motor 52, moves the cleaning roller 35 (i.e., cleaner) from the contact position (illustrated in FIG. 2) to the separate position (illustrated in FIG. 3) or from the separate position to the contact position during rotation of the pressure roller 31, which is a cleaning or contact target for the cleaning roller 35 to clean the surface of the pressure roller 31.

On the other hand, in a case in which the temperature detected by the temperature sensor 45 (i.e., temperature detector) is equal to or smaller the given value A, the moving assembly 60, constructed of the arm 38 and the motor 52, moves the cleaning roller 35 (i.e., cleaner) from the contact position to the separate position or from the separate position to the contact position during a stop of rotation of the pressure roller 31 (i.e., cleaning target).

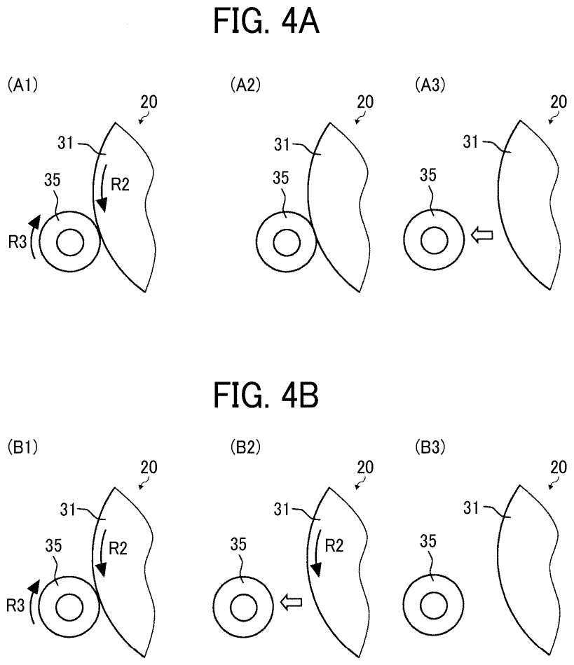

Referring now to FIGS. 4A and 4B, a detailed description is given of movements of the pressure roller 31 and the cleaning roller 35 when the cleaning roller 35 is separated from the pressure roller 31 in the fixing device 20.

FIG. 4A is a diagram illustrating rotary motions of the pressure roller 31 in association with separation of the cleaning roller 35 from the pressure roller 31 when the temperature of the cleaning roller 35 detected by the temperature sensor 45 (i.e., detected temperature) is equal to or smaller than the given value A.

As illustrated in Section (A1) of FIG. 4A, as the pressure roller 31 is rotated together with the fixing roller 21 by the drive motor 51 under the control of the controller 50, the cleaning roller 35 in contact with the pressure roller 31 is also rotated in a clockwise direction of rotation R3. When the controller 50 determines that it is time to separate the cleaning roller 35 from the pressure roller 31, the drive motor 51 stops driving and rotating the fixing roller 21, thereby stopping rotation of the pressure roller 31 while the cleaning roller 35 is kept in contact with the pressure roller 31 as illustrated in Section (A2) of FIG. 4A. Then, as illustrated in Section (A3) of FIG. 4A, the cleaning roller 35 is separated from the pressure roller 31 not rotating.

On the other hand, FIG. 4B is a diagram illustrating rotary motions of the pressure roller 31 in association with separation of the cleaning roller 35 from the pressure roller 31 when the temperature of the cleaning roller 35 detected by the temperature sensor 45 (i.e., detected temperature) is greater than the given value A.

As illustrated in Section (B1) of FIG. 4B, as the pressure roller 31 is rotated together with the fixing roller 21 by the drive motor 51 under the control of the controller 50, the cleaning roller 35 in contact with the pressure roller 31 is also rotated in the clockwise direction of rotation R3. When the controller 50 determines that it is time to separate the cleaning roller 35 from the pressure roller 31, the cleaning roller 35 is separated from the pressure roller 31 while the drive motor 51 keeps driving and rotating the fixing roller 21, thereby keeping rotation of the pressure roller 31 as illustrated in Section (B2) of FIG. 4B. Then, as illustrated in Section (B3) of FIG. 4B, the drive motor 51 stops driving and rotating the fixing roller 21, thereby stopping rotation of the pressure roller 31 after the cleaning roller is separated from the pressure roller 31.

Thus, in the fixing device 20, the cleaning roller 35 is separated from the pressure roller 31 while the pressure roller 31 stops rotating or while the pressure roller 31 keeps rotating, depending on the temperature of the cleaning roller 35. Accordingly, the fixing device 20 maintains an enhanced cleanability of the cleaning roller 35 while preventing the extraneous matter such as toner adhering to the surface of the cleaning roller 35 from returning to the surface of the pressure roller 31.

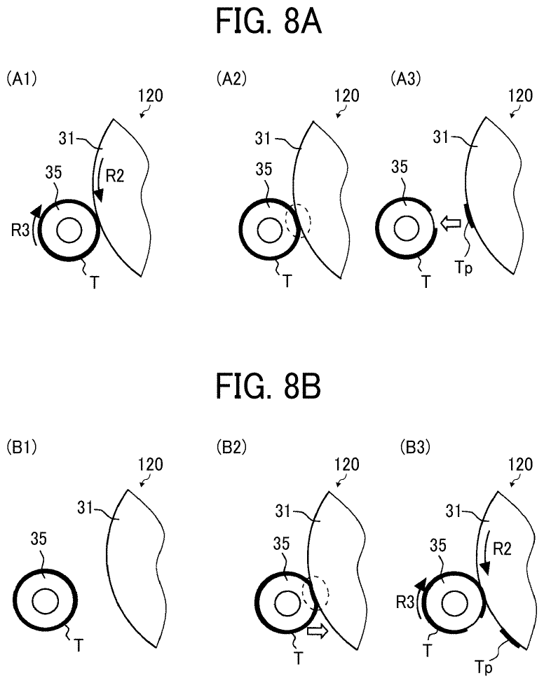

To provide a fuller understanding of the embodiments of the present disclosure, a description is now given of movements of the pressure roller 31 and the cleaning roller 35 when the cleaning roller 35 is separated from the pressure roller 31 in a comparative fixing device 120, with reference to FIG. 8A.

FIG. 8A is a diagram illustrating rotary motions of the pressure roller 31 in association with separation of the cleaning roller 35 from the pressure roller 31 in the comparative fixing device 120. Specifically, Section (A1) of FIG. 8A illustrates that the cleaning roller 35 in contact with the pressure roller 31 is rotated in the clockwise direction of rotation R3 by the pressure roller 31 that rotates in the counterclockwise direction of rotation R2. Section (A2) of FIG. 8A illustrates that the pressure roller 31 stops rotating while the cleaning roller 35 is kept in contact with the pressure roller 31. Section (A3) of FIG. 8A illustrates that the cleaning roller 35 is separated from the pressure roller 31 not rotating. When the cleaning roller 35 is separated from the pressure roller 31 not rotating, an unfavorable situation may arise. Specifically, as illustrated in Section (A3) of FIG. 8A, extraneous matter such as the toner T adhering to the surface of the cleaning roller 35 may partially move or return, as partial extraneous matter Tp, to the surface of the pressure roller 31 from the pressure contact position, encompassed by a broken line in Section (A2) of FIG. 8A, between the pressure roller 31 and the cleaning roller 35. Such an unfavorable situation arises depending on whether the temperature of the cleaning roller 35 reaches the given value A (hereinafter occasionally referred to as a melting temperature) or not when the cleaning roller 35 is separated from the pressure roller 31. Specifically, such an unfavorable situation arises when the temperature of the extraneous matter (e.g., toner T) on the cleaning roller 35 reaches a high temperature (i.e., melting temperature) together with the cleaning roller 35. The extraneous matter reaching the melting temperature melts and moves toward the pressure roller 31. In short, the extraneous matter is offset.

The given value A (i.e., melting temperature) described above is a maximum temperature that does not cause the unfavorable situation in which the extraneous matter (mainly toner), which has moved from the surface of the pressure roller 31 to the surface of the cleaning roller 35, returns to the surface of the pressure roller 31. In other words, the given value A is a maximum temperature that does not cause the extraneous matter to return from the surface of the cleaning roller 35 to the surface of the pressure roller 31 (i.e., cleaning target).

The unfavorable situation described above soils the surface of the pressure roller 31. As a consequence, the sheet P is also soiled while passing through the fixing nip. In addition, an image formed on the sheet P may be partially lost. In addition, such reverse movement of extraneous matter causes an uneven layer of the extraneous matter on the surface of the cleaning roller 35 as illustrated in Section (A3) of FIG. 8A. When the cleaning roller 35 contacts the pressure roller 31 again, the cleaning roller 35 may cause a rotation failure, resulting in a cleaning failure.

To address such situations, in the present embodiment, when the temperature of the cleaning roller 35 reaches the given value A (i.e., melting temperature) and therefore the reverse movement of the extraneous matter (as the partial extraneous matter Tp) is likely to occur, the cleaning roller 35 is separated from the pressure roller 31 while the pressure roller 31 keeps rotating. That is, the cleaning roller 35 is separated from the pressure roller 31 without causing a local pressure contact portion on the cleaning roller 35. Accordingly, the unfavorable situation described above is prevented.

On the other hand, in the present embodiment, when the temperature of the cleaning roller 35 does not reach the given value A (i.e., melting temperature) and therefore the reverse movement of the extraneous matter (as the partial extraneous matter Tp) is unlikely to occur, the cleaning roller 35 is separated from the pressure roller 31 while the pressure roller 31 stops rotating. Such a configuration prevents the cleaning roller 35 from failing to clean the pressure roller 31 from when the cleaning roller 35 is separated from the pressure roller 31 until when the pressure roller 31 stops rotating.

In short, the cleaning roller 35 is separated from the pressure roller 31 while the pressure roller 31 keeps rotating when the temperature of the cleaning roller 35 is high enough to cause the reverse movement of the extraneous matter (as the partial extraneous matter Tp). By contrast, when the temperature of the cleaning roller 35 is insufficient to cause the reverse movement of the extraneous matter (as the partial extraneous matter Tp), the cleaning roller is separated from the pressure roller 31 after the pressure roller 31 stops rotating. Accordingly, in the present embodiment, the cleaning roller 35 exhibits an enhanced cleanability.

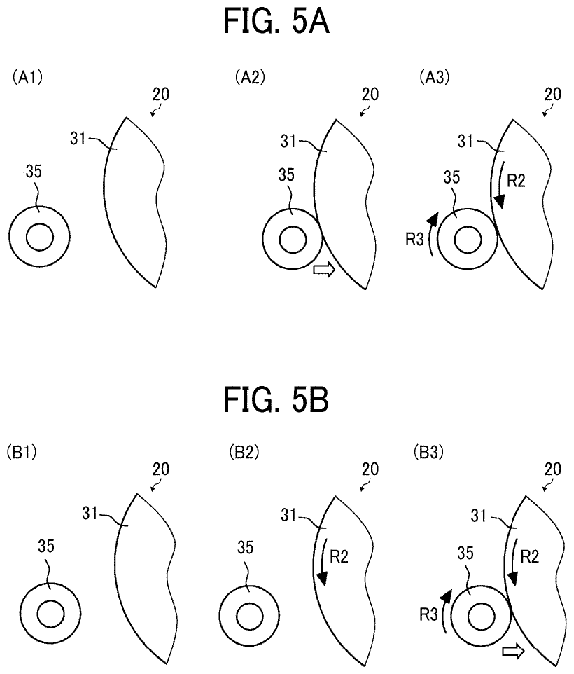

Referring now to FIGS. 5A and 5B, a detailed description is given of movements of the pressure roller 31 and the cleaning roller 35 when the cleaning roller 35 comes into contact with the pressure roller 31 in the fixing device 20.

FIG. 5A is a diagram illustrating rotary motions of the pressure roller 31 in association with the cleaning roller 35 coming into contact with the pressure roller 31 when the temperature of the cleaning roller 35 detected by the temperature sensor 45 (i.e., detected temperature) is equal to or smaller than the given value A.

As illustrated in Section (A1) of FIG. 5A, the rotation of the pressure roller 31 is stopped together with the fixing roller 21 by the drive motor 51 under the control of the controller 50; whereas the cleaning roller 35 is separated from the pressure roller 31. When the controller 50 determines that it is time for the cleaning roller 35 to come into contact with the pressure roller 31, the cleaning roller 35 comes into contact with the pressure roller 31 while the drive motor 51 stops driving and rotating the fixing roller 21, thereby stopping rotation of the pressure roller 31 as illustrated in Section (A2) of FIG. 5A. Then, as illustrated in Section (A3) of FIG. 5A, the drive motor 51 drives and rotates the fixing roller 21, thereby rotating the pressure roller 31 after the cleaning roller 35 contacts the pressure roller 31.

On the other hand, FIG. 5B is a diagram illustrating rotary motions of the pressure roller 31 in association with the cleaning roller 35 coming into contact with the pressure roller 31 when the temperature of the cleaning roller 35 detected by the temperature sensor 45 (i.e., detected temperature) is greater than the given value A.

As illustrated in Section (B1) of FIG. 5B, the rotation of the pressure roller 31 is stopped together with the fixing roller 21 by the drive motor 51 under the control of the controller 50; whereas the cleaning roller 35 is separated from the pressure roller 31. When the controller 50 determines that it is time for the cleaning roller 35 to come into contact with the pressure roller 31, the drive motor 51 drives and rotates the fixing roller 21, thereby rotating the pressure roller 31 while the cleaning roller 35 is apart from the pressure roller 31 as illustrated in Section (B2) of FIG. 5B. Then, as illustrated in Section (B3) of FIG. 5B, the cleaning roller 35 comes into contact with the pressure roller 31 rotating.

Thus, in the fixing device 20, the cleaning roller 35 comes into contact with the pressure roller 31 while the pressure roller 31 stops rotating or while the pressure roller 31 keeps rotating, depending on the temperature of the cleaning roller 35. Accordingly, the fixing device 20 maintains an enhanced cleanability of the cleaning roller 35 while preventing the extraneous matter such as toner adhering to the surface of the cleaning roller 35 from returning to the surface of the pressure roller 31.

To provide a fuller understanding of the embodiments of the present disclosure, a description is now given of movements of the pressure roller 31 and the cleaning roller 35 when the cleaning roller 35 comes into contact with the pressure roller 31 in the comparative fixing device 120, with reference to FIG. 8B.

FIG. 8B is a diagram illustrating rotary motions of the pressure roller 31 in association with the cleaning roller 35 coming into contact with the pressure roller 31 in the comparative fixing device 120. Specifically, Section (B1) of FIG. 8B illustrates that the cleaning roller 35 is separated from the pressure roller 31 not rotating. Section (B2) of FIG. 8B illustrates that the cleaning roller 35 comes into contact with the pressure roller 31 while the pressure roller 31 stops rotation. Section (B3) of FIG. 8B illustrates that the cleaning roller 35 in contact with the pressure roller 31 is rotated in the clockwise direction of rotation R3 by the pressure roller 31 that rotates in the counterclockwise direction of rotation R2. When the cleaning roller 35 contacts the pressure roller 31 not rotating, an unfavorable situation may arise. Specifically, as illustrated in Section (B3) of FIG. 8B, the extraneous matter such as the toner T adhering to the surface of the cleaning roller 35 may partially move or return, as partial extraneous matter Tp, to the surface of the pressure roller 31 from the pressure contact position, encompassed by a broken line in Section (B2) of FIG. 8B, between the pressure roller 31 and the cleaning roller 35. Such an unfavorable situation arises depending on whether the temperature of the cleaning roller 35 reaches the given value A (i.e., melting temperature) or not when the cleaning roller 35 contacts the pressure roller 31. Specifically, such an unfavorable situation arises when the temperature of the extraneous matter (e.g., toner T) on the cleaning roller 35 reaches a high temperature (i.e., melting temperature) together with the cleaning roller 35. The extraneous matter reaching the melting temperature melts and moves toward the pressure roller 31. In short, the extraneous matter is offset as in the example described above with reference to FIG. 8A in which the cleaning roller 35 is separated from the pressure roller 31.

The unfavorable situation described above soils the surface of the pressure roller 31. As a consequence, the sheet P is also soiled while passing through the fixing nip. In addition, an image formed on the sheet P may be partially lost. In addition, such reverse movement of extraneous matter causes an uneven layer of the extraneous matter on the surface of the cleaning roller 35 as illustrated in Section (B3) of FIG. 8B. As a consequence, the cleaning roller 35 may cause a rotation failure, resulting in a cleaning failure.

To address such situations, in the present embodiment, when the temperature of the cleaning roller 35 reaches the given value A (i.e., melting temperature) and therefore the reverse movement of the extraneous matter (as the partial extraneous matter Tp) is likely to occur, the cleaning roller 35 comes into contact with the pressure roller 31 while the pressure roller 31 keeps rotating. That is, the cleaning roller 35 contacts the pressure roller 31 without causing a local pressure contact portion on the cleaning roller 35. Accordingly, the unfavorable situation described above is prevented.

On the other hand, in the present embodiment, when the temperature of the cleaning roller 35 does not reach the given value A (i.e., melting temperature) and therefore the reverse movement of the extraneous matter (as the partial extraneous matter Tp) is unlikely to occur, the cleaning roller 35 comes into contact with the pressure roller 31 while the pressure roller 31 stops rotating. Such a configuration prevents the cleaning roller 35 from failing to clean the pressure roller 31 from when the pressure roller 31 starts rotating until when the cleaning roller 35 contacts the pressure roller 31.

In short, the cleaning roller 35 comes into contact with the pressure roller 31 while the pressure roller 31 keeps rotating when the temperature of the cleaning roller 35 is high enough to cause the reverse movement of the extraneous matter (as the partial extraneous matter Tp). By contrast, when the temperature of the cleaning roller 35 is insufficient to cause the reverse movement of the extraneous matter (as the partial extraneous matter Tp), the cleaning roller 35 comes into contact with the pressure roller 31 while the pressure roller 31 stops rotating. Accordingly, in the present embodiment, the cleaning roller 35 exhibits an enhanced cleanability.

Here, the temperature sensor 45 is disposed to detect the temperature of the cleaning roller 35 outside a maximum sheet conveyance area in the fixing nip. The maximum sheet conveyance area refers to a range in a width direction of a sheet P having a maximum size conveyable through the fixing nip.

Since the sheet P draws heat from the pressure roller 31 (and the fixing roller 21) in the sheet conveyance area, the temperature outside the maximum conveyance area tends to increase. Since the cleaning roller 35 receives heat from the pressure roller 31 in such an increased temperature area outside the maximum sheet conveyance area, the temperature sensor 45 detects the temperature of the cleaning roller 35 located in such an increased temperature area to quickly detect the time when the cleaning roller 35 reaches the melting temperature.

The melting temperature described above varies depending on the toner used, the components of the paper powder, and the like. Therefore, the given value A described above is settable to an optimum value for each model of image forming apparatus employing different types of toner. The given value A described above is also variable according to the sheet P conveyed.

In the present embodiment, based on a surface temperature of the cleaning roller 35 directly detected by the temperature sensor 45 (i.e., temperature detector), the controller 50 determines whether to cause the cleaning roller 35 to come into contact with or apart from the pressure roller 31 while the pressure roller 31 stops rotating or whether to cause the cleaning roller 35 to come into contact with or apart from the pressure roller 31 while the pressure roller 31 keeps rotating.

Alternatively, when the temperature of the cleaning roller 35 is indirectly detected by detection of the temperature of the pressure roller 31 due to a relatively high correlation between the change in the surface temperature of the pressure roller 31 and the change in the surface temperature of the cleaning roller 35, the controller 50 determines whether to cause the cleaning roller 35 to come into contact with or apart from the pressure roller 31 while the pressure roller 31 stops rotating or whether to cause the cleaning roller 35 to come into contact with or apart from the pressure roller 31 while the pressure roller 31 keeps rotating, based on the temperature of the pressure roller 31 detected by the temperature sensor 41 (i.e., temperature detector). Since such a configuration reduces the number of temperature sensors, the fixing device can be downsized and manufactured at reduced cost.

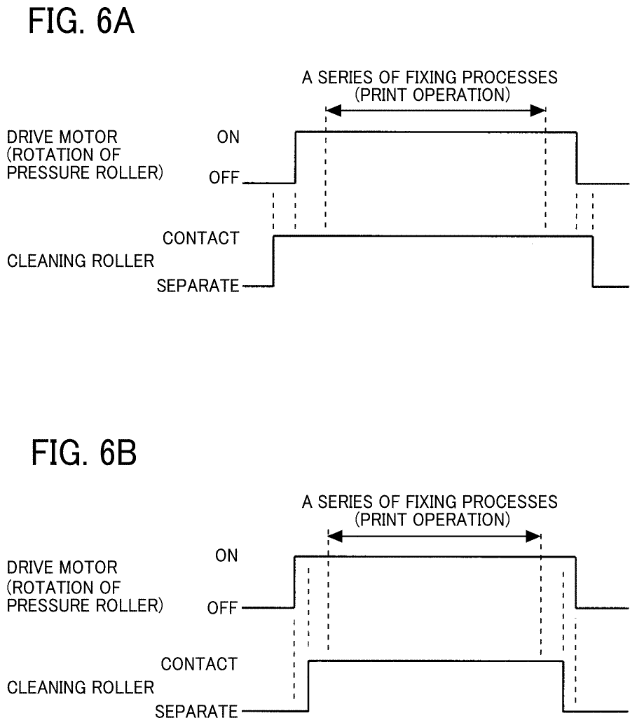

Referring now to FIGS. 6A and 6B, a description is given of the timing of rotation of the pressure roller 31 and the timing of contact/separation of the cleaning roller 35 with respect to a series of fixing processes.

FIG. 6A is a timing chart illustrating a rotation control of the pressure roller 31 and a contact/separation control of the cleaning roller 35 when the detected temperature is equal to or smaller than the given value A. FIG. 6B is a timing chart illustrating the rotation control of the pressure roller 31 and the contact/separation control of the cleaning roller 35 when the detected temperature is greater than the given value A.

In the present embodiment, the moving assembly 60 moves the cleaning roller 35 (i.e., cleaner) from the separate position to the contact position before the series of fixing processes (i.e., print operation) starts. Specifically, as illustrated in FIGS. 6A and 6B, the cleaning roller 35 is located at the contact position, from the separate position, at the time when the series of fixing processes (i.e., print operation) starts, regardless of whether the temperature detected by the temperature sensor 45 is greater than the given value A or not. That is, at the time of warming up before the series of fixing processes, the cleaning roller 35 comes into contact with the pressure roller 31 while the pressure roller 31 stops rotating or while the pressure roller 31 keeps rotating, based on the temperature detected by the temperature sensor 45.

Similarly, the moving assembly 60 moves the cleaning roller 35 from the contact position to the separate position after the series of fixing processes (i.e., print operation) is completed. Specifically, as illustrated in FIGS. 6A and 6B, the cleaning roller 35 is eventually located at the separate position, from the contact position, after the series of fixing processes (i.e., print operation) is completed, regardless of whether the temperature detected by the temperature sensor 45 is greater than the given value A or not. That is, at the time of cooling down after the series of fixing processes, the cleaning roller 35 is separated from the pressure roller 31 while the pressure roller 31 stops rotating or while the pressure roller 31 keeps rotating, based on the temperature detected by the temperature sensor 45.

Such rotation control of the pressure roller 31 and the contact/separation control of the cleaning roller 35 maintain a reliable series of fixing processes while providing various advantages described above.

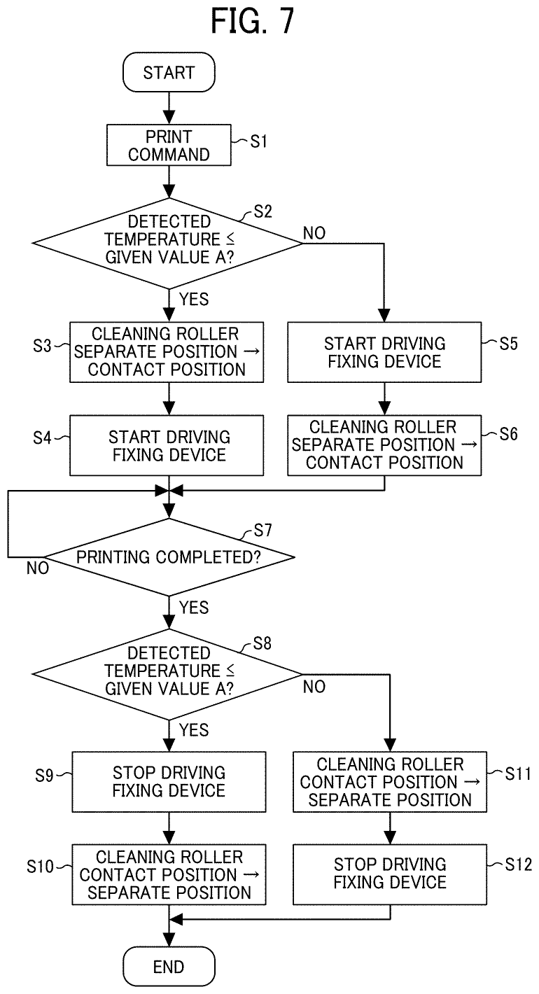

Referring now to FIG. 7, a description is given of the contact/separation control of the cleaning roller 35 together with a driving control of the fixing device 20.

FIG. 7 is a flowchart illustrating the contact/separation control of the cleaning roller and the driving control of the fixing device 20.

As illustrated in FIG. 7, when a user presses a print button of the image forming apparatus 1, for example, the controller 50 receives a print command in step S1.

In step S2, the controller 50 determines whether the temperature detected by the temperature sensor 45 is equal to or smaller than the given value A.

When the controller 50 determines that the temperature detected by the temperature sensor 45 is equal to or smaller than the given value A (YES in step S2), the controller 50 determines that the extraneous matter may not return from the cleaning roller 35 to the pressure roller 31. Therefore, the controller 50 moves the cleaning roller 35 from the separate position to the contact position while stopping the driving of the fixing device 20 (more specifically, the pressure roller 31) in step S3. In step S4, the controller 50 starts driving the fixing device 20 (more specifically, the pressure roller 31) after moving the cleaning roller 35 to the contact position.

By contrast, when the controller 50 determines that the temperature detected by the temperature sensor 45 is greater than the given value A (NO in step S2), the controller 50 determines that the extraneous matter may return from the cleaning roller 35 to the pressure roller 31. Therefore, the controller 50 starts driving the fixing device 20 (more specifically, the pressure roller 31) in step S5. In step S6, the controller 50 moves the cleaning roller 35 from the separate position to the contact position after driving the fixing device 20 (more specifically, the pressure roller 31).

Thereafter, a series of printing processes is executed while the cleaning roller 35 is in contact with the pressure roller 31 until printing is completed in step S7. That is, when the controller 50 determines that the printing is not completed yet (NO in step S7), the series of printing processes continues while the cleaning roller 35 is in contact with the pressure roller 31.

By contrast, when the controller 50 determines that the printing is completed (YES in step S7), the controller 50 determines again whether the temperature detected by the temperature sensor 45 is equal to or smaller than the given value A in step S8.

When the controller 50 determines that the temperature detected by the temperature sensor 45 is equal to or smaller than the given value A (YES in step S8), the controller 50 determines that the extraneous matter may not return from the cleaning roller 35 to the pressure roller 31. Therefore, the controller 50 stops driving the fixing device 20 (more specifically, the pressure roller 31) in step S9. In step S10, the controller 50 moves the cleaning roller 35 from the contact position to the separate position while stopping the driving of the fixing device 20 (more specifically, the pressure roller 31).

By contrast, when the controller 50 determines that the temperature detected by the temperature sensor 45 is greater than the given value A (NO in step S8), the controller 50 determines that the extraneous matter may return from the cleaning roller 35 to the pressure roller 31. Therefore, the controller 50 moves the cleaning roller 35 from the contact position to the separate position while keeping the driving of the fixing device 20 (more specifically, the pressure roller 31) in step S11. In step S12, the controller 50 stops driving the fixing device 20 (more specifically, the pressure roller 31) after moving the cleaning roller 35 to the separate position.

Thus, the flow of the contact/separation control of the cleaning roller 35 and the driving control of the fixing device 20 ends.

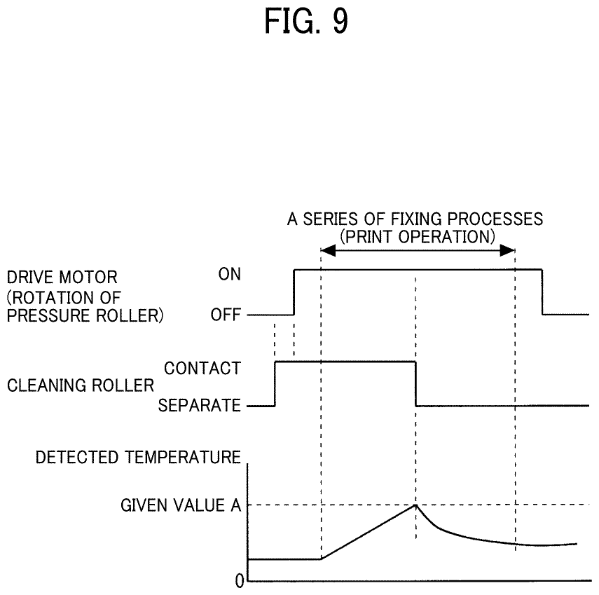

Referring now to FIG. 9, a description is given of a first variation of the rotation control of the pressure roller 31 and the contact/separation control of the cleaning roller 35 described above.

FIG. 9 is a timing chart illustrating the first variation of the rotation control of the pressure roller 31 and the contact/separation control of the cleaning roller 35, together with a graph of changes in the detected temperature.

In the first variation illustrated in FIG. 9, when the moving assembly 60 moves the cleaning roller 35 (i.e., cleaner) from the contact position (illustrated in FIG. 2) to the separate position (illustrated in FIG. 3) during the series of fixing processes (i.e., print operation), the moving assembly 60 does not move the cleaning roller 35 back from the separate position to the contact position during the series of fixing processes (i.e., print operation) even when the temperature detected by the temperature sensor 45 (i.e., temperature detector) is equal to or smaller than the given value A.

In other words, when the cleaning roller 35 is separated from the pressure roller 31 during the series of fixing processes, the cleaning roller 35 does not come into contact with the pressure roller 31 until the end of the series of fixing processes, regardless of the temperature of the cleaning roller 35 after the cleaning roller 35 is separated from the pressure roller 31. The cleaning roller 35 keeps apart from the pressure roller 31 even after the series of fixing processes is completed.

Specifically, as described above with reference to FIGS. 6A and 6B, the cleaning roller 35 (i.e., cleaner) moves from the separate position to the contact position before the series of fixing processes (i.e., print operation) starts in the first variation. More specifically, the cleaning roller 35 is located at the contact position, from the separate position, at the time when the series of fixing processes (i.e., print operation) starts, regardless of whether the temperature detected by the temperature sensor 45 is greater than the given value A or not. That is, at the time of warming up before the series of fixing processes, the cleaning roller 35 comes into contact with the pressure roller 31 while the pressure roller 31 stops rotating or while the pressure roller 31 keeps rotating, based on the temperature detected by the temperature sensor 45.

However, unlike the movement of the cleaning roller 35 described above with reference to FIGS. 6A and 6B, the cleaning roller 35 moves from the contact position to the separate position during the series of fixing processes (i.e., print operation) in the first variation. Specifically, as illustrated in the lower graph of FIG. 9, when the temperature detected by the temperature sensor 45 reaches the given value A, the cleaning roller 35 moves from the contact position to the separate position even during the series of fixing processes. Such contact/separation control of the cleaning roller 35 prevents the cleaning roller 35 from exceeding the given value A (i.e., melting temperature) during the series of fixing processes. Accordingly, a reliable series of fixing processes is maintained while various advantages are provided as described above.

As illustrated in the lower graph of FIG. 9, the temperature of the cleaning roller 35 gradually decreases as the cleaning roller 35 is separated from the pressure roller 31 during the series of fixing processes (i.e., print operation). Although the temperature of the cleaning roller 35 becomes equal to or smaller than the given value A, the cleaning roller 35 does not come into contact with the pressure roller 31 again during the series of fixing processes (i.e., print operation). Such contact/separation control of the cleaning roller 35 prevents image disturbance caused by the cleaning roller 35 coming into contact with the pressure roller 31 during the series of fixing processes. Such contact/separation control of the cleaning roller 35 also prevents a sharp drop in pressure temperature, thereby enhancing the image quality.

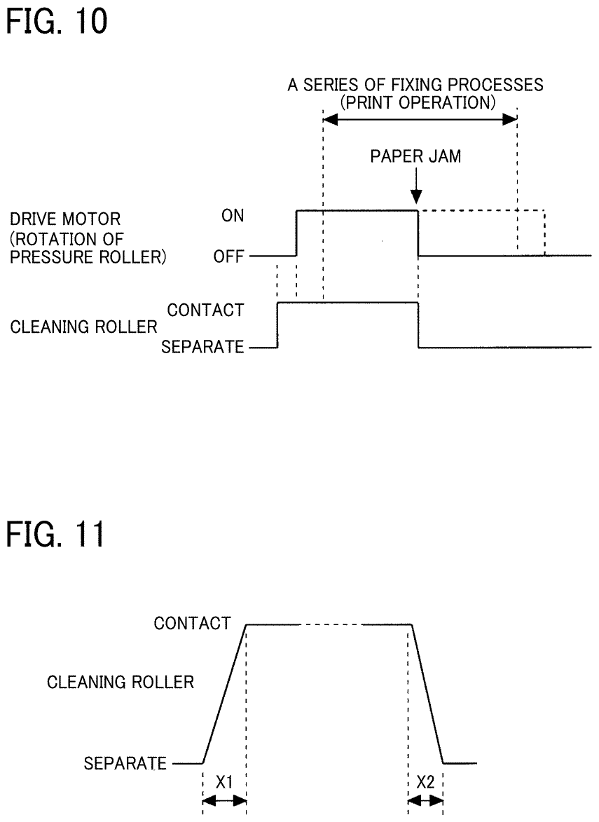

Referring now to FIG. 10, a description is given of a second variation of the rotation control of the pressure roller 31 and the contact/separation control of the cleaning roller 35 described above.

FIG. 10 is a timing chart illustrating the second variation of the rotation control of the pressure roller 31 and the contact/separation control of the cleaning roller 35.

In the second variation illustrated in FIG. 10, when a jam of a sheet P (i.e., paper jam) occurs during the series of fixing processes (i.e., print operation), the moving assembly 60 moves the cleaning roller 35 (i.e., cleaner) from the contact position (illustrated in FIG. 2) to the separate position (illustrated in FIG. 3), regardless of the temperature detected by the temperature sensor 45 (i.e., temperature detector).

Specifically, when the sheet P is jammed in the conveyance passage during the series of fixing processes (i.e., print operation), the cleaning roller 35 uniformly moves from the contact position to the separate position. This is because the cleaning roller 35 in contact with the pressure roller 31 hampers removal of the sheet P jammed in the fixing device 20. In particular, the contact/separation control of the cleaning roller 35 described above is advantageous when the sheet P jammed is wound around the pressure roller 31. Note that a paper jam is detected by a photosensor (or sheet sensor) disposed along the conveyance passage (particularly, near the fixing device 20) in the image forming apparatus 1.

Thus, when such a paper jam occurs, the cleaning roller 35 moves from the contact position to the separate position regardless of the temperature of the cleaning roller 35. Accordingly, the second variation facilitates the removal of the sheet P jammed, thereby enhancing the work efficiency. In addition, the second variation prevents erroneous detection by the temperature sensor 45, which may be caused by the sheet P jammed (or residual paper).

Referring now to FIG. 11, a description is given of a third variation of the contact/separation control of the cleaning roller 35 described above.

FIG. 11 is a timing chart illustrating the third variation of the contact/separation control of the cleaning roller 35.

In the third variation, a moving speed V2 of the cleaning roller 35 (i.e., cleaner) from the contact position (illustrated in FIG. 2) to the separate position (illustrated in FIG. 3) is higher than a moving speed V1 of the cleaning roller 35 from the separate position to the contact position. In short, a relation of V1<V2 is satisfied. In other words, the cleaning roller 35 moves faster from the contact position to the separate position than from the separate position to the contact position.

That is, as illustrated in FIG. 11, a time X2 taken for the cleaning roller 35 to move from the contact position to the separate position is shorter than a time X1 taken for the cleaning roller 35 to move from the separate position to the contact position. In short, a relation of X1>X2 is satisfied.

Specifically, the motor 52 that causes the cleaning roller 35 to come into contact with and apart from the pressure roller 31 is a motor that can vary the rotational speed or the number of rotations. When the motor 52 is driven in the forward direction to cause the cleaning roller 35 to contact the pressure roller 31, the number of rotations of the motor 52 is smaller than the number of rotations of the motor 52 when the motor 52 is driven in the reverse direction to separate the cleaning roller 35 from the pressure roller 31.

Such a configuration allows the cleaning roller 35 to quickly come apart from the pressure roller 31 to prevent the extraneous matter (e.g., toner) on the cleaning roller 35 from melting when the temperature of the pressure roller 31 or the cleaning roller 35 rises. Accordingly, the third variation prevents the reverse movement of the extraneous matter (e.g., toner) from the cleaning roller 35 to the pressure roller 31. In addition, when the cleaning roller 35 comes into contact with the pressure roller 31, the cleaning roller 35 moves slowly toward the pressure roller 31 at the moving speed V1 (hereinafter, occasionally referred to as a relatively low moving speed V1), thereby reducing the impact or shock resulting from the contact between the cleaning roller 35 and the pressure roller 31. In particular, when the cleaning roller 35 comes into contact with the pressure roller 31 during the series of fixing processes, such a gentle contact between the cleaning roller 35 and the pressure roller 31 does not vibrate or disturb an image to be fixed. When the cleaning roller 35 is apart from the pressure roller 31, the temperature of the cleaning roller 35 and the temperature of the pressure roller 31 may be different from each other. Specifically, the temperature of the cleaning roller 35 may be lower than the temperature of the pressure roller 31. When the cleaning roller 35 comes into contact with the pressure roller 31, the cleaning roller 35, having a lower temperature than the temperature of the pressure roller 31, gradually and slowly comes into contact with the pressure roller 31 at the moving speed V1. As a consequence, the temperature difference between the cleaning roller 35 and the pressure roller 31 is gradually reduced so that the cleaning roller 35 and the pressure roller 31 have identical temperatures. That is, the temperature of the extraneous matter (e.g., toner) adhering to the surface of the cleaning roller 35 does not rapidly increase. Accordingly, the extraneous matter (e.g., toner) does not melt or return to the pressure roller 31. On the other hand, the pressure roller 31 is slowly contacted by the cleaning roller 35 having a lower temperature than the temperature of the pressure roller 31. Therefore, the surface temperature of the pressure roller 31 does not rapidly decrease, thereby preventing a decrease in the fixing temperature and formation of faulty images.

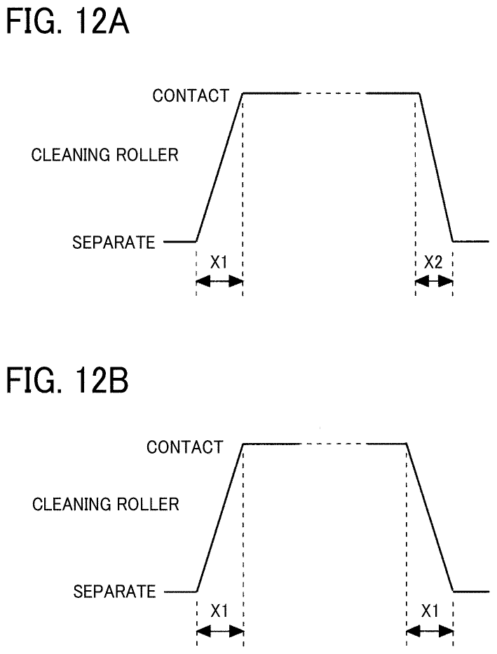

Referring now to FIGS. 12A and 12B, a description is given of a fourth variation of the contact/separation control of the cleaning roller 35 described above.

FIG. 12A is a timing chart illustrating the fourth variation of the contact/separation control of the cleaning roller 35 when the pressure roller 31 rotates. FIG. 12B is a timing chart illustrating the fourth variation of the contact/separation control of the cleaning roller 35 when the pressure roller 31 stops rotation.

In the fourth variation, when the pressure roller 31 (i.e., pressure rotator) as a cleaning or contact target for the cleaning roller 35 (i.e., cleaner) rotates, the moving speed V2 of the cleaning roller 35 from the contact position to the separate position is higher than the moving speed V1 of the cleaning roller 35 from the separate position to the contact position. In short, the relation of V1<V2 is satisfied. In other words, the cleaning roller 35 moves faster from the contact position to the separate position than from the separate position to the contact position. Like the third variation described above, when the cleaning roller 35 comes apart from or in contact with the pressure roller 31 while the pressure roller 31 keeps rotating as illustrated in FIGS. 4B and 5B, respectively, the time X2 taken for the cleaning roller 35 to move from the contact position to the separate position is shorter than the time X1 taken for the cleaning roller 35 to move from the separate position to the contact position as illustrated in FIG. 12A. In short, the relation of X1>X2 is satisfied. Accordingly, the fourth variation provides substantially the same advantages as the advantages described above in the third variation.

On the other hand, when the pressure roller 31 as a cleaning or contact target for the cleaning roller 35 stops rotation, the moving speed V1 of the cleaning roller 35 from the contact position to the separate position is substantially the same as the moving speed V1 of the cleaning roller 35 from the separate position to the contact position. In other words, the cleaning roller 35 moves from the contact position to the separate position and from the separate position to the contact position at substantially identical speeds. That is, when the cleaning roller 35 comes apart from or in contact with the pressure roller 31 while the pressure roller 31 stops rotation as illustrated in FIGS. 4A and 5A, respectively, the time X1 taken for the cleaning roller 35 to move from the contact position to the separate position is substantially the same as the time X1 taken for the cleaning roller 35 to move from the separate position to the contact position as illustrated in FIG. 12B.

A description is now given of the reason for performing the control as illustrated in FIG. 12B in the fourth variation.

When the temperature of the pressure roller 31 and the temperature of the cleaning roller 35 are not so high, that is, when the temperature sensor 45 detects a temperature equal to or smaller than the given value A (i.e., melting temperature), the cleaning roller 35 remains in contact with the pressure roller 31 until the pressure roller 31 stops, so as to increase cleaning effectiveness. However, if the cleaning roller 35 is left and cooled in contact with the pressure roller 31 after the pressure roller 31 stops rotating, the toner (as an example of extraneous matter) sandwiched between the pressure roller 31 and the cleaning roller 35 is fixed at the contact position. When the pressure roller 31 starts rotating again, the toner peels and adheres to the pressure roller 31 as the partial extraneous matter Tp as illustrated in FIG. 8A, resulting in formation of defective images. To address such a situation, preferably, the cleaning roller 35 is separated from the pressure roller 31 immediately when the pressure roller 31 stops rotating. At this time, if the cleaning roller 35 is separated from the pressure roller 31 at the moving speed V2 (hereinafter, occasionally referred to as a relatively high moving speed V2), the toner sandwiched and accumulated between the pressure roller 31 and the cleaning roller 35 is likely to peel and adhere to the surface of the pressure roller 31 as the partial extraneous matter Tp, due to a certain degree of viscosity of the accumulated toner. The toner peeling and adhering to the surface of the pressure roller 31 as the partial extraneous matter Tp may be transferred onto an image to be fixed in a next series of fixing processes. The toner peeling and adhering to the surface of the pressure roller 31 as the partial extraneous matter Tp may also recess a portion of the surface of the cleaning roller 35 as illustrated in FIG. 8A, resulting in a rotational failure of the cleaning roller 35.

To address such unfavorable situations, while the pressure roller 31 stops rotation, the cleaning roller 35 is separated from the pressure roller 31 at the relatively low moving speed V1, which is the same speed at which the cleaning roller 35 comes into contact with the pressure roller 31.

The cleaning roller 35 comes into contact with the pressure roller 31 at the relatively low moving speed V1 while the pressure roller 31 stops rotating and while the pressure roller 31 keeps rotating. Accordingly, the temperature of the toner sandwiched and accumulated between the pressure roller 31 and the cleaning roller 35 at the contact position does not increase instantaneously. As a consequence, the toner does not peel and return to the surface of the pressure roller 31 as the partial extraneous matter Tp. In addition, the impact and vibration are reduced when the cleaning roller 35 contacts the pressure roller 31. Such reduced impact and vibration prevents damage to the cleaning roller 35 and the pressure roller 31.

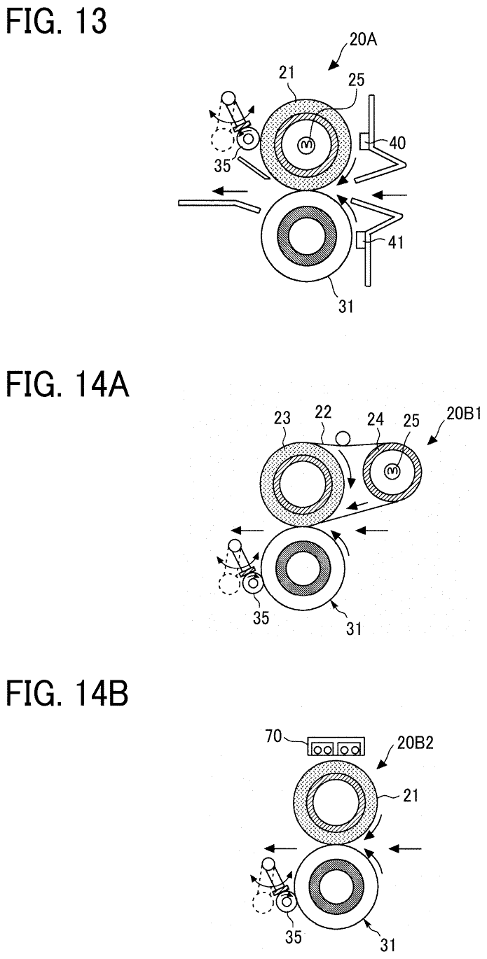

Referring now to FIG. 13, a description is given of a first variation of the fixing device 20 described above.

FIG. 13 is a cross-sectional view of a fixing device 20A as the first variation of the fixing device 20 illustrated in FIG. 2.

In the fixing device 20A illustrated in FIG. 13, the cleaning roller 35 (i.e., cleaner) is configured to contact the surface of the fixing roller 21 (i.e., fixing rotator) to clean the surface of the fixing roller 21. That is, the fixing roller 21 is herein a cleaning target for the cleaning roller 35.

Like the fixing device 20 described above, in the fixing device 20A, in a case in which the temperature of the cleaning roller 35 detected by the temperature sensor 45 (or the temperature of the fixing roller 21 detected by the temperature sensor 40) is greater than a given value A1, the cleaning roller 35 comes into contact with or apart from the fixing roller 21 during rotation of the fixing roller 21. By contrast, in a case in which the temperature detected by the temperature sensor 45 (or the temperature detected by the temperature sensor 40) is equal to or smaller than the given value A1, the cleaning roller 35 comes into contact with or apart from the fixing roller 21 during a stop of rotation of the fixing roller 21. In this case, the given value A1 (i.e., melting temperature) described above is a maximum temperature that does not cause an unfavorable situation in which extraneous matter (mainly toner), which has moved from the surface of the fixing roller 21 to the surface of the cleaning roller 35, returns to the surface of the fixing roller 21. In other words, the given value A1 is a maximum temperature that does not cause the extraneous matter to return from the surface of the cleaning roller 35 to the surface of the fixing roller 21 (i.e., cleaning target).

Note that, in the fixing device 20A, the temperature sensor 45 is a contact temperature sensor such as a contact thermistor that contacts the cleaning roller 35.

Such a configuration maintains an enhanced cleanability of the cleaning roller 35 while preventing the extraneous matter adhering to the surface of the cleaning roller 35 from returning to the surface of the fixing roller 21.

Note that the embodiments or variations applied to the fixing device 20 in which the cleaning roller 35 comes into contact with or apart from the pressure roller 31 is naturally applicable to the fixing device 20A.

Referring now to FIGS. 14A and 14B, a description is given of a second variation of the fixing device 20 described above.

FIG. 14A is a cross-sectional view of a fixing device 20B1 as a first example of the second variation of the fixing device 20 illustrated in FIG. 2. FIG. 14B is a cross-sectional view of a fixing device 20B2 as a second example of the second variation of the fixing device illustrated in FIG. 2.

The fixing device 20 and the fixing device 20A described above are roller fixing devices employing a heating system. The fixing devices to which the embodiments of the present disclosure are applicable are not limited to such roller fixing devices. The embodiments are applicable to various types of fixing devices.

For example, the embodiments are applicable to the fixing device 20B1, which is a belt fixing device employing the heating system as illustrated in FIG. 14A. Specifically, the fixing device 20B1 includes a fixing belt 22 as a fixing rotator. In the fixing device 20B1, the fixing belt 22 is stretched and supported by a plurality of rollers such as an auxiliary fixing roller 23, a heating roller 24, and a tension roller. The auxiliary fixing roller 23 presses against the pressure roller 31 via the fixing belt 22, thereby forming a fixing nip between the fixing belt 22 and the pressure roller 31. The heater 25 is secured inside the heating roller 24 having a hollow structure.

The embodiments are also applicable to the fixing device 20B2, which is a roller fixing device employing an electromagnetic induction system or an induction heating (IH) system as illustrated in FIG. 14B. In the fixing device 20B2, the fixing roller 21 is constructed of, e.g., a core, an elastic layer resting on the core, a heat generation layer resting on the elastic layer, and a release layer resting on the heat generation layer. The heat generation layer is electromagnetically heated by an induction heater 70 that includes an exciting coil wound.

The embodiments are also applicable to a roller fixing device employing a resistive heat generation system. In such a fixing device, a fixing roller is constructed of, e.g., a hollow core, an elastic layer resting on the core, and a release layer resting on the elastic layer. A resistive heat generator is disposed to contact a hollow portion of the hollow core of the fixing roller.

Above-mentioned variations of the fixing device 20 provide substantially the same advantages as the advantages of the fixing device 20 described above.

As described above, in the fixing device 20, the moving assembly 60, constructed of the arm 38 and the motor 52, moves the cleaning roller 35 (i.e., cleaner) from the contact position to the separate position or from the separate position to the contact position during rotation of the pressure roller 31 (i.e., pressure rotator) serving as a cleaning target for the cleaning roller 35, in a case in which the temperature of the cleaning roller 35 detected by the temperature sensor 45 (i.e., temperature detector) or the temperature of the pressure roller 31 (i.e., cleaning target) detected by the temperature sensor 41 (i.e., temperature detector) is greater than the given value A. By contrast, in a case in which the temperature detected by the temperature sensor 45 or the temperature sensor 41 (i.e., temperature detector) is equal to or smaller than the given value A, the moving assembly 60 moves the cleaning roller 35 (i.e., cleaner) from contact position to the separate position or from the separate position to the contact position during a stop of rotation of the pressure roller 31 (i.e., pressure rotator) serving as a cleaning target for the cleaning roller 35.

Accordingly, the fixing device 20 maintains an enhanced cleanability of the cleaning roller 35 while preventing the extraneous matter adhering to the surface of the cleaning roller from returning to the surface of the pressure roller 31.

Note that, in the fixing devices described above, the pressure roller 31 is used as a pressure rotator. Alternatively, a pressure belt may be used as a pressure rotator.

In addition, a cooler may be disposed to contact the cleaning roller 35 (i.e., cleaner) at the separate position to cool down the cleaning roller 35 and prevent the cleaning roller 35 from easily reaching a high temperature.

Such cases also provide substantially the same advantages as the advantages described above.

Note that the width direction is herein defined as a direction perpendicular to the sheet conveyance direction D.

The sheet P is herein defined as any sheet-like recording medium, such as general paper, coated paper, label paper, overhead projector (OHP) transparency, or a film sheet.

The series of fixing processes herein include processes of heating and fixing one or more toner images onto one or more sheets. In the series of fixing processes, the one or more toner images are heated and fixed onto the one or more sheets while the fixing device is continuously driven without stopping.

According to the embodiments of the present disclosure, an image forming apparatus includes a fixing device that maintains an enhanced cleanability of a cleaner while preventing extraneous matter adhering to a surface of the cleaner from returning to a surface of a fixing rotator or a surface of a pressure rotator.

Although the present disclosure makes reference to specific embodiments, it is to be noted that the present disclosure is not limited to the details of the embodiments described above. Thus, various modifications and enhancements are possible in light of the above teachings, without departing from the scope of the present disclosure. It is therefore to be understood that the present disclosure may be practiced otherwise than as specifically described herein. For example, elements and/or features of different embodiments may be combined with each other and/or substituted for each other within the scope of the present disclosure. The number of constituent elements and their locations, shapes, and so forth are not limited to any of the structure for performing the methodology illustrated in the drawings.

Any one of the above-described operations may be performed in various other ways, for example, in an order different from that described above.

What is claimed is:

1. A fixing device comprising:
a fixing rotator configured to heat a toner image and fix the toner image onto a surface of a recording medium;
a pressure rotator configured to press against the fixing rotator to form a fixing nip through which the recording medium is conveyed between the fixing rotator and the pressure rotator;
a cleaner configured to contact and clean a surface of a cleaning target, the cleaning target including one of the fixing rotator and the pressure rotator;
a moving assembly configured to move the cleaner between a contact position at which the cleaner contacts the surface of the cleaning target and a separate position at which the cleaner is apart from the surface of the cleaning target; and
a temperature detector configured to detect a temperature of one of the cleaner and the cleaning target,
the moving assembly being configured to move the cleaner from the contact position to the separate position or from the separate position to the contact position during rotation of the cleaning target, in a case in which the temperature detected by the temperature detector is greater than a given value.

2. The fixing device according to claim 1,
wherein the moving assembly is configured to move the cleaner from the contact position to the separate position or from the separate position to the contact position during a stop of rotation of the cleaning target, in a case in which the temperature detected by the temperature detector is equal to or smaller than the given value.

3. The fixing device according to claim 1,
wherein the moving assembly is configured to move the cleaner from the separate position to the contact position before a series of fixing processes starts, and
wherein the moving assembly is configured to move the cleaner from the contact position to the separate position after the series of fixing processes is completed.

4. The fixing device according to claim 1,
wherein the moving assembly is configured to move the cleaner from the contact position to the separate position during a series of fixing processes, and
wherein the moving assembly is configured not to move the cleaner back from the separate position to the contact position during the series of fixing processes, in a case in which the temperature detected by the temperature detector is equal to or smaller the given value.

5. The fixing device according to claim 1,
wherein the moving assembly is configured to move the cleaner from the contact position to the separate position regardless of the temperature detected by the temperature detector, in response to a jam of the recording medium during a series of fixing processes.

6. The fixing device according to claim 1,
wherein the cleaner is configured to move faster from the contact position to the separate position than from the separate position to the contact position.

7. The fixing device according to claim 1,
wherein the cleaner is configured to move faster from the contact position to the separate position than from the separate position to the contact position during the rotation of the cleaning target, and
wherein the cleaner is configured to move from the contact position to the separate position and from the separate position to the contact position at substantially identical speeds during a stop of rotation of the cleaning target.

8. The fixing device according to claim 1,
wherein the given value is a maximum temperature that does not cause extraneous matter to return from a surface of the cleaner to the surface of the cleaning target.

9. The fixing device according to claim 1,
wherein the cleaner includes a cleaning roller that is configured to rotate together with the cleaning target when the cleaner is in contact with the cleaning target rotating in a given direction.

10. The fixing device according to claim 1,
wherein the moving assembly includes:
an arm configured to rotatably hold the cleaner; and
a motor configured to rotate the arm.

11. An image forming apparatus comprising:
an image bearer configured to bear a toner image; and
the fixing device according to claim 1,
the fixing device being configured to fix the toner image onto the surface of the recording medium.

12. A fixing device comprising:
a fixing rotator configured to heat a toner image and fix the toner image onto a surface of a recording medium;
a pressure rotator configured to press against the fixing rotator to form a fixing nip through which the recording medium is conveyed between the fixing rotator and the pressure rotator;
a cleaner configured to contact and clean a surface of a cleaning target, the cleaning target including one of the fixing rotator and the pressure rotator;
a moving assembly configured to move the cleaner between a contact position at which the cleaner contacts the surface of the cleaning target and a separate position at which the cleaner is apart from the surface of the cleaning target; and
a temperature detector configured to detect a temperature of one of the cleaner and the cleaning target,
the moving assembly being configured to move the cleaner from the contact position to the separate position or from the separate position to the contact position during a stop of rotation of the cleaning target, in a case in which the temperature detected by the temperature detector is equal to or smaller than a given value.

13. The fixing device according to claim 12,
wherein the moving assembly includes:
an arm configured to rotatably hold the cleaner; and
a motor configured to rotate the arm.

14. An image forming apparatus comprising:
an image bearer configured to bear a toner image; and
the fixing device according to claim 12,
the fixing device being configured to fix the toner image onto the surface of the recording medium.
